(19) United States
(12) Patent Application Publication
(10) Pub. No.: US 2019/0172625 A1
(43) Pub. Date: Jun. 6, 2019

(54) REACTOR AND REACTOR MANUFACTURING METHOD

(71) Applicant: TOYOTA JIDOSHA KABUSHIKI KAISHA, Toyota-shi (JP)

(72) Inventor: Keita TSUCHIYAMA, Miyoshi-shi (JP)

(73) Assignee: TOYOTA JIDOSHA KABUSHIKI KAISHA, Toyota-shi (JP)

(21) Appl. No.: 16/197,894

(22) Filed: Nov. 21, 2018

(30) Foreign Application Priority Data
Dec. 6, 2017 (JP) 2017-234589

(51) Int. Cl. H01F 27/26; H01F 27/02; H01F 41/00

(52) U.S. Cl. CPC H01F 27/263; H01F 27/2823; H01F 41/005; H01F 27/022

(57) ABSTRACT

A reactor may include a pair of core blocks, an end surface of one of the core blocks being opposed to an end surface of the other of the core blocks; a gap plate interposed between the end surfaces of the core blocks; and a bobbin constituted of resin and covering side surfaces of the pair of core blocks and a side surface of the gap plate, wherein the gap plate may include a plurality of protrusions contacting the end surfaces of the core blocks, and an inner surface of the bobbin may include a positioning portion that contacts an edge of the gap plate at a position separated from the protrusions.

### CROSS-REFERENCE TO RELATED APPLICATION

This application claims priority to Japanese Patent Application No. 2017-234589, filed on Dec. 6, 2017, the entire contents of which are incorporated herein by reference.

### TECHNICAL FIELD

The disclosure herewith relates to a reactor and a reactor manufacturing method.

### BACKGROUND

A reactor is a passive element in which a coil is wound on a bobbin through which a core is inserted. A reactor is known in which a core is divided into a plurality of core blocks and a gap plate is interposed between each pair of adjacent core blocks inside a bobbin. For example, JP 2016-122764 describes such a reactor. In the reactor of JP 2016-122764, a bobbin is provided with grooves at its inner periphery, and gap plates are arranged in the grooves. Positions of the gap plates are accurately set by the grooves.

### SUMMARY

A bobbin may be formed around core blocks by insert molding. In the insert molding, so-called flash (or burrs) may be generated around solidified resin. The flash is generated at a boundary between objects to be inserted in a mold and a cavity of the mold, that is, at a boundary between the bobbin and the core blocks. A bobbin part may be insert molded for each of adjacent core blocks and the two bobbin parts provided with the core blocks may be joined with a gap plate interposed therebetween to manufacture a reactor. In the case where the two bobbin parts with the core blocks are joined with the gap plate interposed therebetween, a position of the gap plate would be displaced if flash is caught between the core blocks and the gap plate. The disclosure herein provides a reactor having a shape suitable for insert molding a bobbin, and a reactor manufacturing method.

A reactor disclosed herein may comprise a pair of core blocks, a gap plate, and a bobbin. An end surface of one of the core blocks may be opposed to an end surface of the other of the core blocks. The gap plate may be interposed between the end surfaces of the core blocks. The reactor disclosed herein may comprise three or more core blocks. In the technique disclosed herein, a focus will be placed on the pair of core blocks adjacent to each other with the gap plate interposed therebetween. The bobbin may be a cylindrical insulation member into which a core is inserted, and it may surround side surfaces of the pair of core blocks and a side surface of the gap plate. The bobbin may be constituted of resin. The bobbin at least needs to surround boundaries between the core blocks and the gap plate. The gap plate may include a plurality of protrusions contacting the end surfaces of the core blocks. An inner surface of the bobbin may include a positioning portion that contacts an edge of the gap plate at a position separated from the protrusions. In this reactor, since the protrusions of the gap plate contacting the core blocks are separated from the positioning portion contacting the edge of the gap plate, when flash is generated around the positioning portion, the flash would not be caught between any of the protrusions of the gap plate and one or both of the core blocks.

In the reactor disclosed herein, a gap may be provided between the inner surface of the bobbin and the edge of the gap plate except at the positioning portion. The flash may be generated at the boundaries between the bobbin and the core blocks. Due to this, so long as the gap is secured between the inner surface of the bobbin and the gap plate, the flash enters this gap and does not affect positioning of the gap plate. The gap may be filled by another resin after the bobbin, the gap plate, and the core blocks are assembled.

The positioning portion may be configured as follows, for example. The gap plate may include a notch at the edge at the position separated from the protrusions. The positioning portion may include a projection that projects from the inner surface of the bobbin and fits the notch. Alternatively, the positioning portion may be configured as follows. The gap plate may include a positioning projection that projects from the edge of the gap plate at the position separated from the protrusions as seen along a normal direction of the gap plate. The positioning portion may include a recess that is provided in the inner surface of the bobbin and fits the positioning projection.

The aforementioned reactor may be manufactured by a method described below. The method may comprise preparing the pair of core blocks and the gap plate that includes the plurality of protrusions on surfaces of the gap plate that are to face the end surfaces of the core blocks; insert-molding bobbin parts for the core blocks respectively, each of the bobbin parts surrounding the side surface of corresponding one of the core blocks; and arranging the core blocks to be opposed to each other such that the gap plate is interposed between the end surfaces of the core blocks with the protrusions being in contact with the end surfaces, and joining the bobbin parts to complete the bobbin. The insert-molding of the bobbin parts may include forming the positioning portion that contacts the edge of the gap plate on at least one of the bobbin parts, the positioning portion being formed at a position separated from the protrusions of the gap plate in a state where the gap plate is attached to the at least one of the bobbin parts. Even when the flash is generated around the positioning portion upon the insert molding, the flash is prevented from being caught between the protrusions of the gap plate and the core blocks since the protrusions of the gap plate are separated from the positioning portion.

Details and further improvements of the technique disclosed herein will be described in Detailed Description below.

### BRIEF DESCRIPTION OF DRAWINGS

FIG. 1 is a perspective view of a reactor.

FIG. 2 is a cross-sectional view of the reactor along an XY plane in FIG. 1.

FIG. 3 is a disassembled perspective view of the reactor before bobbin parts (a bobbin) are formed.

FIG. 4 is a disassembled perspective view of the reactor after the bobbin parts have been formed (before gap plates are attached).

FIG. 5 is a disassembled perspective view of the reactor after the bobbin parts have been formed (after the gap plates have been attached).

FIG. 6 is a front view of the gap plate attached to the bobbin part.

FIG. 7 is a cross-sectional view along a line VII-VII in FIG. 6.

FIG. 8 is a front view of a gap plate of a first variant.

FIG. 9 is a front view of a gap plate of a second variant.

FIG. 10 is a front view of a gap plate of a third variant.

FIG. 11 is a front view of a gap plate of a fourth variant.

### DETAILED DESCRIPTION

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved reactor and reactor manufacturing method, as well as methods for using the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

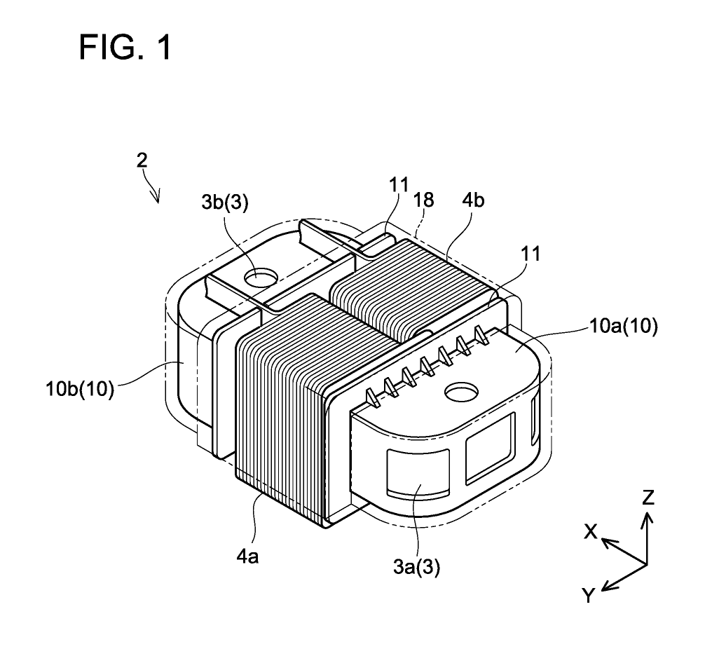

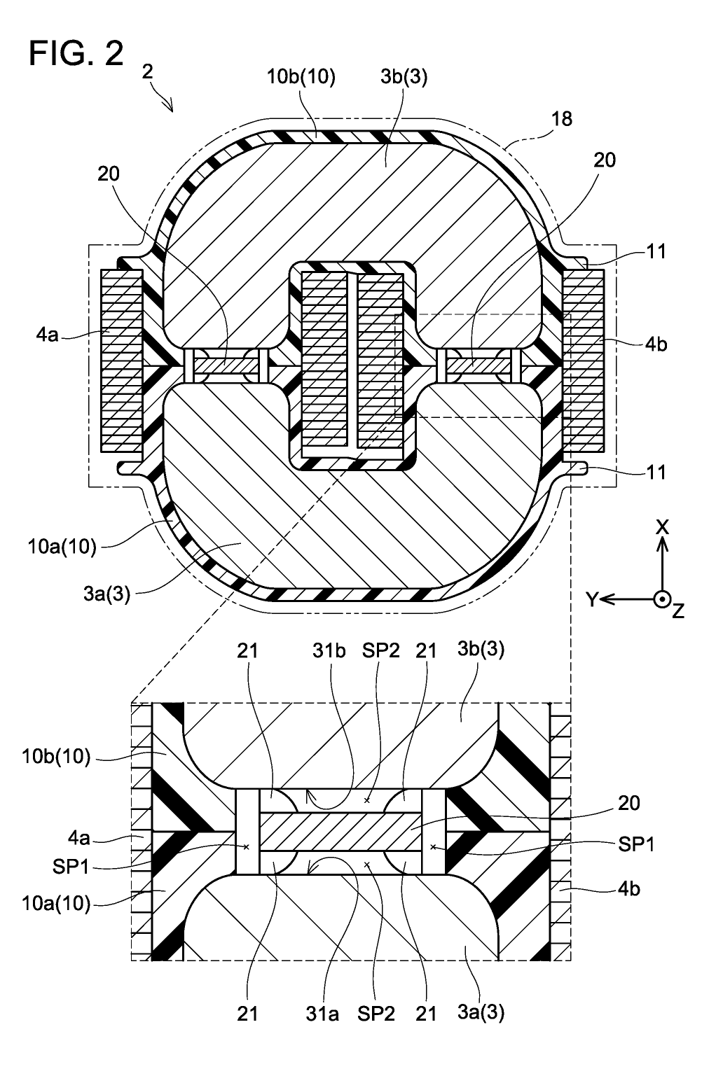

A reactor 2 of an embodiment will be described with reference to the drawings. FIG. 1 shows a perspective view of the reactor 2. FIG. 2 shows a cross sectional view of the reactor 2 along an XY plane according to a coordinate system shown in FIG. 1. The reactor 2 includes a ring-shaped core 3, a bobbin 10, coils 4a, 4b, and a resin cover 18. In FIGS. 1 and 2, the resin cover 18 is depicted with a virtual line to allow a structure inside the resin cover 18 to be seen. A lower portion of FIG. 2 shows an enlarged view of a rectangular range with a broken line shown in an upper portion of FIG. 2.

The ring-shaped core 3 is constituted of a pair of U-shaped core blocks 3a, 3b and gap plates 20. The pair of core blocks 3a, 3b is arranged such that their end surfaces 31a, 31b at ends of the U-shapes are opposed to each other, and each of the gap plates 20 is interposed between its corresponding pair of the end surfaces 31a, 31b (see the lower portion of FIG. 2).

The ring-shaped core 3 is covered by the bobbin 10. More specifically, the core block 3a is covered by a bobbin part 10a, and the core block 3b is covered by a bobbin part 10b. The bobbin part 10a covering the core block 3a and the bobbin part 10b covering the core block 3b are joined with the gap plates 20 interposed therebetween, by which the ring-shaped core 3 and the bobbin 10 are completed. When the bobbin parts 10a, 10b are joined, portions of the U-shaped core blocks 3a, 3b corresponding to arms of the U-shapes are inserted to the coils 4a, 4b, and then the bobbin parts 10a, 10b are joined. The coils 4a, 4b are constituted of a single flat wire, and are electrically a single coil. The bobbin 10 is a cylindrical member, on an outside thereof the coils 4a, 4b are wound, and inside thereof the core 3 is inserted. The bobbin 10 of the embodiment also covers curved portions of the core 3, however, the bobbin 10 simply needs to cover portions of the core 3 where the coils 4a, 4b are wound, that is, side surfaces of the core 3 on both sides of each gap plate 20. The bobbin 10 includes flanges 11 that restrict movement of the coils 4a, 4b in an axial direction (an X direction in the drawings). The bobbin 10 simply needs to cover the side surfaces of the core 3 and side surfaces of the gap plates 20 at least between a pair of the flanges 11.

The coils 4a, 4b have a square columnar shape. The coils 4a, 4b, the core 3, and the bobbin 10 are covered by the resin cover 18 except for one side surface (bottom surface) of each of the square columnar coils 4a, 4b and a surface of the core 3 (bottom surface of the core 3) facing in the same side as each of the side surfaces.

A structure of one of the gap plates 20 and its surrounding structure will be described with reference to the lower portion of FIG. 2. The gap plates 20 have an identical structure. The gap plate 20 includes protrusions 21 at four corners on each surface thereof that faces the end surface 31a (31b) of the core block 3a (3b). A vertex surface of each protrusion 21 contacts its corresponding end surface 31a (31b), and other portion of this gap plate 20 does not contact the end surface 31a (31b). Thus, a space SP2 is secured between the gap plate 20 and each end surface 31a (31b). Further, a space SP1 is also secured between each of the side surfaces of the gap plate 20 and an inner surface of the bobbin 10. Each of the protrusions 21 is provided with a space therearound except at its portion contacting the corresponding core block 3a (3b). A distance to each end surface 31a (31b) is accurately set for the gap plate 20 by the protrusions 21 at the four corners contacting the end surface 31a (31b) of the core block 3a (3b).

Each bobbin part 10a (10b) is constituted of resin and is insert-molded to its corresponding core block 3a (3b). In the insert molding, each core block 3a (3b) is arranged in a cavity of a mold and molten resin is poured around the core block 3a (3b) to form each of the bobbin parts 10a, 10b. Due to this, flash (or burrs) may be generated at boundaries between the bobbin part 10a (10b) and the core block 3a (3b). When the flash is caught between the protrusions 21 and the end surface 31a (31b), the distance between the gap plate 20 and the end surface 31a (31b) may not be set accurately. Further, when the flash is caught between inner surface of the bobbin part 10a (10b) and the gap plate 20, a position of the gap plate 20 in directions parallel to the end surface 31a (31b) may not be set accurately. The reactor 2 has the gaps secured around the gap plates 20 except at the vertex surfaces of the protrusions 21, so the flash does not affect the positions of the gap plates 20 including the protrusions 21. Next, a manufacturing method of the reactor 2 will be described and the aforementioned advantage will be supplemented. The gaps around the gap plates 20 simply need to exist when the gap plates 20, the core blocks 3a, 3b, and the bobbin parts 10a, 10b are assembled. After the gap plates 20, the core blocks 3a, 3b, and the bobbin parts 10a, 10b have been assembled, the gaps may be filled with another resin.

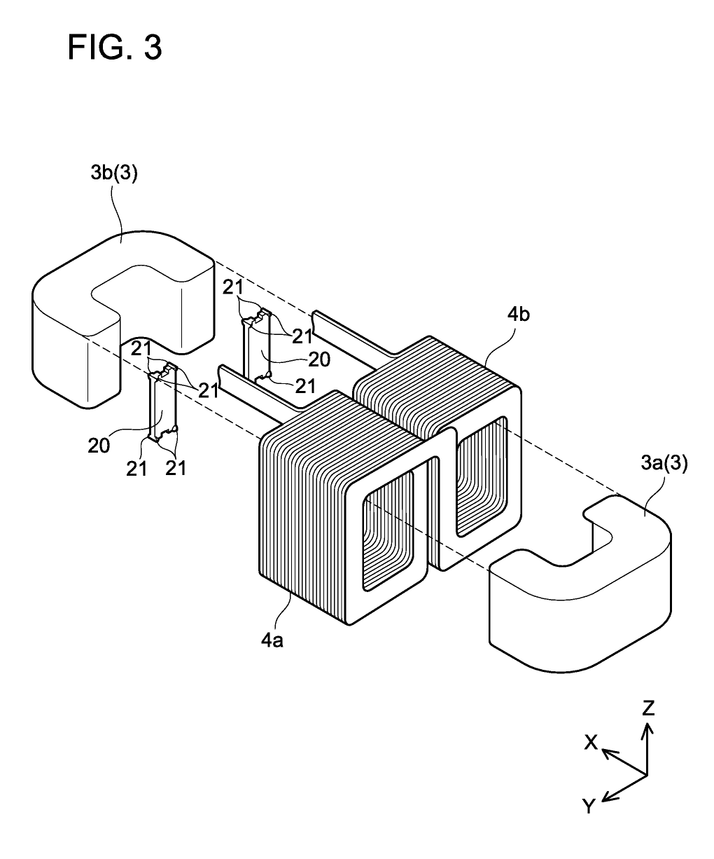

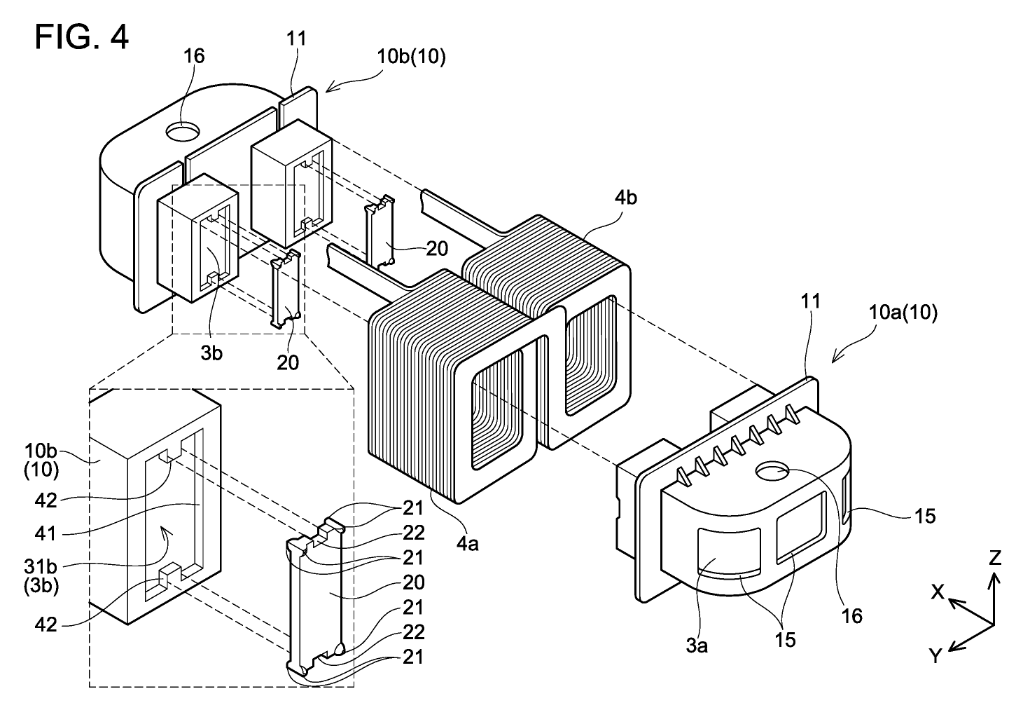

(Preparation Step) In a manufacturing process of the reactor 2, firstly, the pair of core blocks 3a, 3b, the coils 4a, 4b, and the gap plates 20 are prepared (FIG. 3). The protrusions 21 are provided at the four corners of each surface of the gap plates 20 that is to face the corresponding core block 3a (3b). For details of the protrusions 21, FIG. 4 should be referred to.

(Bobbin Forming Step) The bobbin part 10a (10b) is insert-molded for each of the pair of core blocks 3a, 3b such that the bobbin part 10a (10b) surround at least the side surfaces of the core block 3a (3b). FIG. 4 shows each bobbin part 10a (10b) formed to surround peripheries of the U shaped-arm of the core block 3a (3b). Each bobbin part 10a (10b) is provided with the flange 11 restricting the movement of the coils 4a, 4b in the axial direction. Further, each bobbin part 10a (10b) is provided with windows 15, 16 through which the core block 3a (3b) is exposed. The bobbin parts 10a and 10b have an identical shape. Hereinbelow, the core block 3b, the bobbin part 10b surrounding the core block 3b, and the gap plates 20 will mainly be described. Reference signs of the corresponding portions of the bobbin part 10a and the core block 3a will be described in parentheses.

An enlarged view of the end surface of the bobbin part 10b (the end surface 31b of the core block 3b) and one of the gap plates 20 is shown at a left lower portion of FIG. 4. As aforementioned, the protrusions 21 that protrude toward the end surface 31b (31a) are provided at the four corners of the gap plate 20. Further, the gap plate 20 includes notches 22 at its edge at positions separated from the protrusions 21. The notches 22 are provided respectively at two opposite sides of the rectangular gap plate 20. The bobbin part 10b (10a) has a cylindrical shape surrounding the core block 3b (3a) and the gap plate 20, and projections 42 are provided at an inner surface 41 of this cylinder. The projections 42 correspond to the notches 22 of the gap plate 20, and when the gap plate 20 is attached to the bobbin part 10b (10a), the projections 42 fit the notches 22. The fitting of the projections 42 and the notches 22 sets the position of the gap plate 20 in the directions parallel to the end surface 31b (31a) of the core block 3b (3a). The projections 42 provided on the inner surface 41 of the bobbin part 10b (10a) are portions that define the position of the gap plate 20.

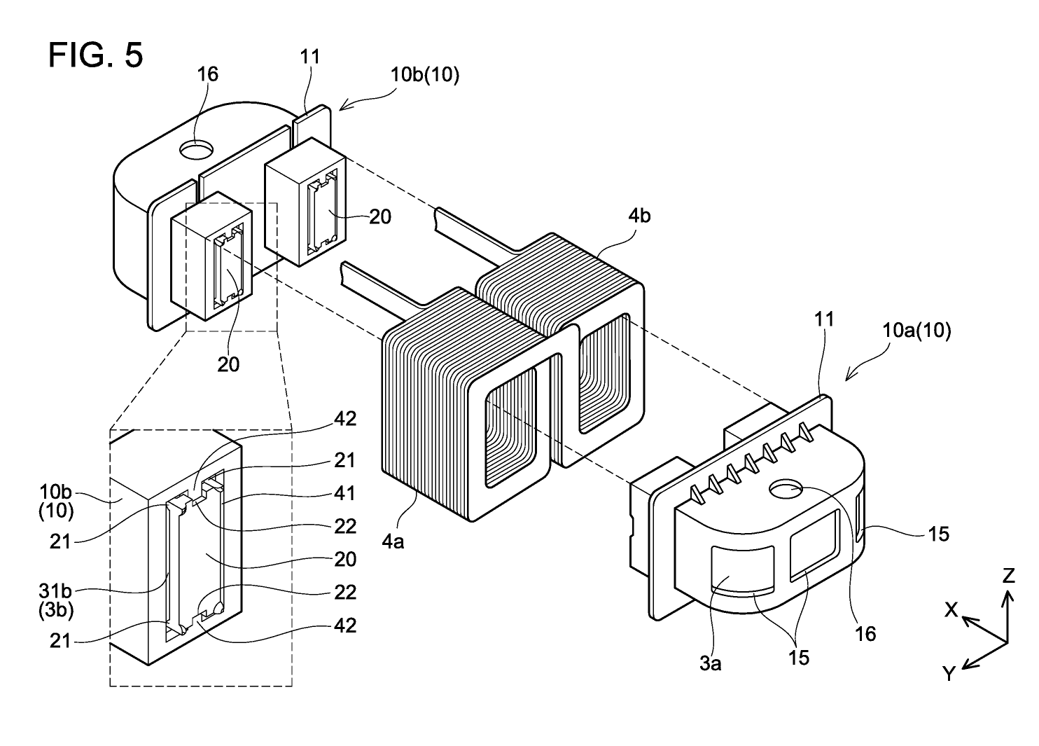

FIG. 5 shows a diagram in which the gap plates 20 are arranged inside the bobbin part 10b. The ends of the bobbin part 10b protrude outward than the end surface 31b of the core block 3b, and the gap plates 20 are arranged inside the ends of the cylinder of the bobbin part 10b.

As aforementioned, the projections 42 of the bobbin part 10b fit the notches 22 provided respectively on the two parallel sides of each gap plate 20, by which positions of the gap plates 20 in an in-plane direction are determined. The “in-plane direction” herein means the directions parallel to the end surface 31b of the core block 3b, as aforementioned.

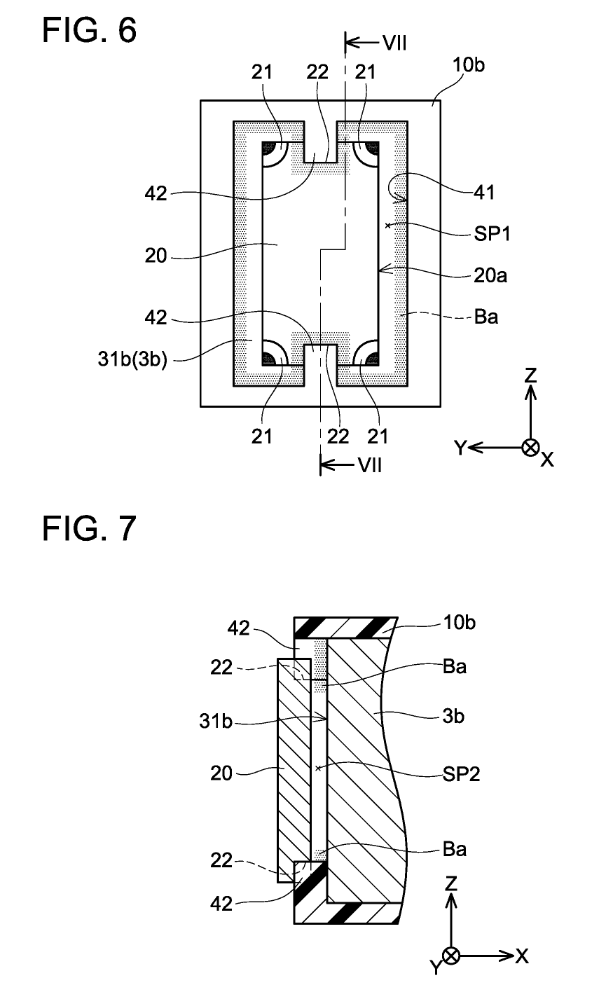

FIG. 6 shows a front view of one of the gap plates 20 attached to the bobbin part 10b, FIG. 7 shows a cross-sectional view along a line VII-VII in FIG. 6. A reference sign 20a in FIG. 6 shows the edge of the gap plate 20 (side surfaces of the gap plate 20). In FIG. 6, blacked-out ranges in the protrusions 21 mean regions to be in contact with the core block 3a (3b). Further, in FIGS. 6 and 7, a light-gray range Ba indicates a region where the flash might be generated upon the insert molding.

As aforementioned, the region where the flash might be generated is the boundary between the bobbin part 10b (10a) and the core block 3b (3a). As shown in FIGS. 6 and 7, the gap plate 20 secures the spaces SP1, SP2 therearound except at the vertex surfaces of the protrusions 21 (the blacked-out ranges in FIG. 6) and at the notches 22. Especially, except for the contact portions between the notches 22 and the projections 42, the space SP1 is secured around the edge 20a of the gap plate 20. As shown in FIG. 7, the space SP2 is also secured between the gap plate 20 (except at the protrusions 21) and the core block 3b, so the edge 20a of the gap plate 20 and the range Ba (the range where the flash might be generated) do not contact each other. The generated flash stays in the spaces SP1, SP2, and is not caught between the protrusions 21 and the end surface 31b (31a). The contact portions between the notches 22 and the projections 42 are also separated from the core block 3b, so the flash does not affect the contact portions between the notches 22 and the projections 42.

(Assembling Step) As shown in FIG. 5, the core blocks 3a, 3b are arranged to be opposed to each other with the gap plates 20 interposed therebetween such that the protrusions 21 contact the end surface 31b (31a) of the core block 3b (3a), and the bobbin parts 10a, 10b are joined to complete the bobbin 10. Adhesive is used for joining the bobbin parts 10a, 10b. The bobbin parts 10a, 10b may be joined by another method, such as ultrasonic joining. As aforementioned, even when the flash is generated at the boundaries between the core block 3b (3a) and the bobbin part 10b (10a), the flash does not contact the gap plates 20, so the positions of the gap plates 20 are not affected by the flash.

Finally, the resin cover 18 shown by the virtual line in FIGS. 1 and 2 is formed. The resin cover 18 is formed by insert molding as well. In forming the resin cover 18, the spaces SP1, SP2 that were secured around the gap plates 20 may be filled by resin of the resin cover 18.

As aforementioned, in the reactor 2 for which the bobbin parts 10a, 10b are formed by the insert molding, portion where the flash is expected to be generated (the range Ba in FIG. 6) is separated from both the vertex surfaces of the protrusions 21 and the notches 22. Further, the gap plates 20 are also separated from the end surface 31b (31a) of the core block 3b (3a) except at the vertex surfaces of the protrusions 21. Due to this, the flash that might be generated at the boundaries between the inner surface 41 of the bobbin part 10b (10a) and the core block 3b does not affect the positions of the gap plates 20.

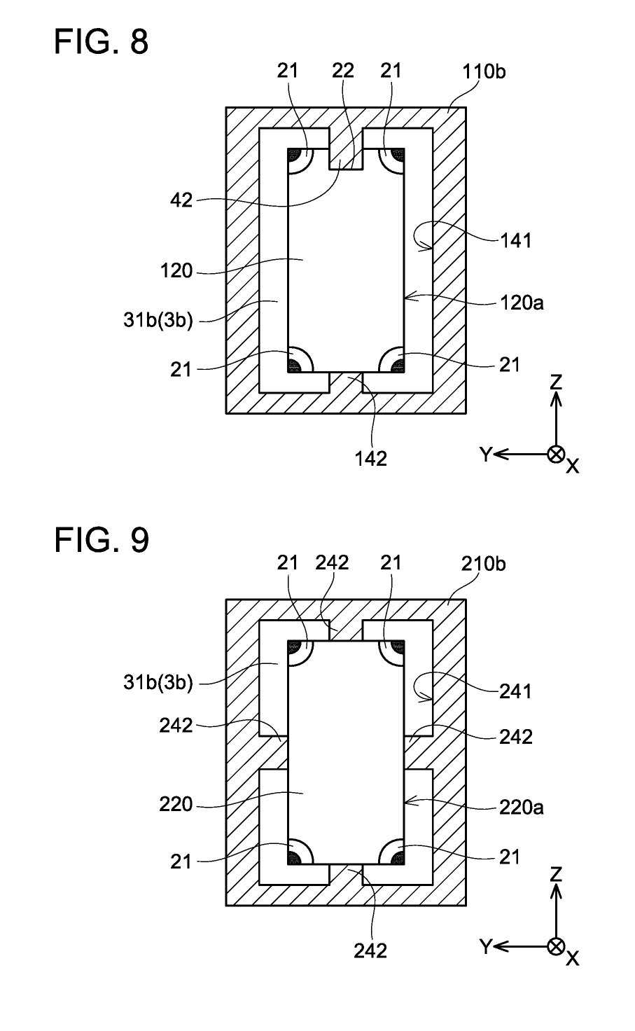

FIG. 8 shows a front view of a gap plate 120 of a variant. In FIGS. 8 and 9 to 11, a bobbin part 110 (210b, 310b) is depicted with hatching for easier understanding.

The gap plate 120 includes one notch 22 at its edge 120a. The bobbin part 110b includes a first projection 42 and a second projection 142 projecting from a cylindrical inner surface 141. The first projection 42 and the second projection 142 are provided at positions opposed to each other on the cylindrical inner surface of the bobbin part 110b. The first projection 42 fits in the notch 22. The second projection 142 is in contact with the edge 120a of the gap plate 120 at an opposite side from the notch 22. The fitting between the notch 22 and the first projection 42 accurately sets a position of the gap plate 120 in a Y direction. Further, the gap plate 120 is interposed between the first projection 42 and the second projection 142, so its position in a Z direction is thereby set accurately.

FIG. 9 shows a front view of a gap plate 220 of a second variant. The gap plate 220 is not provided with a notch at its edge 220a. Meanwhile, the bobbin part 210b includes four projections 242 projecting from a cylindrical inner surface 241. The four projections 242 are in contact with the edge 220a of the rectangular gap plate 220 at its four sides. When seen along a normal direction (X direction), the gap plate 220 is held by the projections 242 projecting from four sides of the inner surface 241, by which its position in a YZ plane is accurately set.

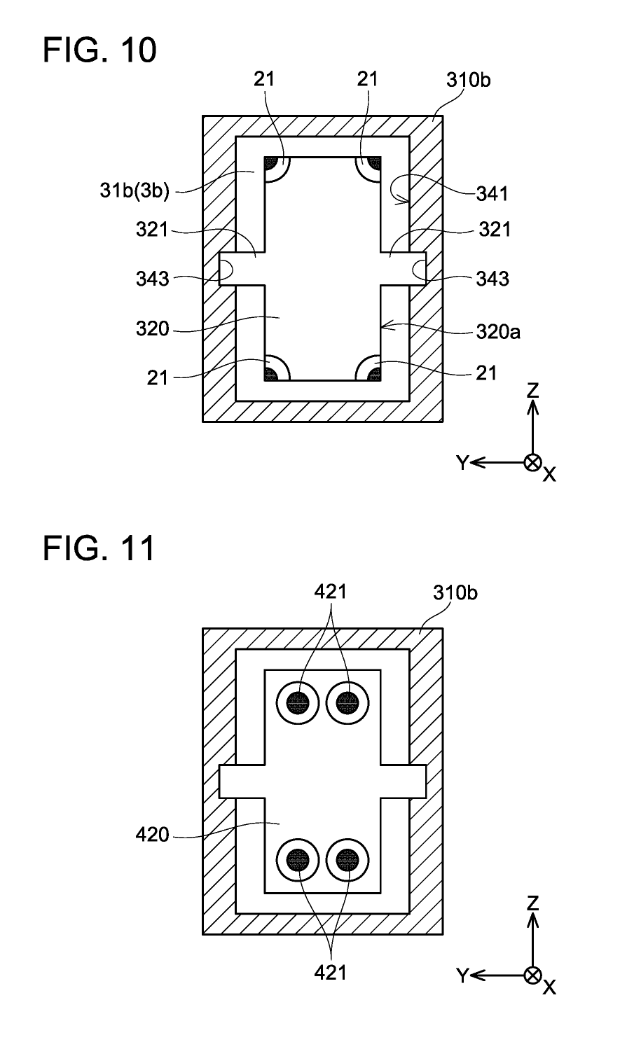

FIG. 10 shows a front view of a gap plate 320 of a third variant. The gap plate 320 includes two projections 321 projecting from its edge 320a when seen along the normal direction (the X direction in the drawing). The projections 321 project to opposite directions from each other. An inner surface 341 of the bobbin part 310 surrounding the gap plate 320 is provided with recesses 343 corresponding to the projections 321 of the gap plate 320. Each of the projections 321 fits its corresponding one of the recesses 343. The fitting between the projections 321 and the recesses 343 accurately sets a position of the gap plate 320 in the in-plane direction.

Each of the gap plates 120, 220, 320 shown in FIGS. 8 to 10 includes the protrusions 21 at its four corners when seen along the normal direction of the gap plate. FIG. 11 shows a front view of a gap plate 420 of a fourth variant. A shape of a contour of the gap plate 420 is the same as that of the gap plate 320 of the third variant. On the gap plate 420, protrusions 421 at its four corners are arranged slightly inward than the protrusions 21 of the other variants. The protrusions are desirably provided at the four corners to contact the edge of the gap plate when seen along the normal direction of the gap plate, however, they may be provided slightly inward than the edge.

Some features regarding the technique described in the embodiment will be described. The reactor 2 of the embodiment includes the core 3 that configures a ring by the pair of U-shaped core blocks 3a, 3b. The technique disclosed herein may be applied to a reactor including three or more core blocks. In a case with the reactor including three or more core blocks, a gap plate may be interposed between a particular pair of the core blocks adjacent to each other, and this gap plate and its surround simply need to have the features described in the embodiment or in any of the variants.

Each of the projections 42, 142, 242, and the recesses 343 provided on the cylindrical inner surfaces of the bobbin parts corresponds to a portion that sets the position of the gap plate (positioning portion). Each of the projections 321 provided in the gap plate 320 of the third variant corresponds to a positioning projection projecting from the edge 320a of the gap plate 320 when seen along the normal direction of the gap plate 320.

In the reactor of the embodiment, a positioning portion for setting an in-plane position of each gap plate is provided in each of the pair of bobbin parts 10a, 10b. However, the positioning portion simply needs to be provided in at least one of the pair of bobbin parts 10a, 10b.

Specific examples of the present invention has been described in detail, however, these are mere exemplary indications and thus do not limit the scope of the claims. The art described in the claims include modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

What is claimed is:

1. A reactor comprising:
a pair of core blocks, an end surface of one of the core blocks being opposed to an end surface of the other of the core blocks;
a gap plate interposed between the end surfaces of the core blocks; and
a bobbin constituted of resin and surrounding side surfaces of the pair of core blocks and a side surface of the gap plate,
wherein
the gap plate includes a plurality of protrusions contacting the end surfaces of the core blocks, and
an inner surface of the bobbin includes a positioning portion that contacts an edge of the gap plate at a position separated from the protrusions.

2. The reactor according to claim 1, wherein
a gap is provided between the inner surface of the bobbin and the edge of the gap plate except at the positioning portion.

3. The reactor according to claim 2, wherein
another resin fills the gap.

4. The reactor according to claim 1, wherein
the gap plate includes a notch at the edge at the position separated from the protrusions, and
the positioning portion includes a projection that projects from the inner surface of the bobbin and fits the notch.

5. The reactor according to claim 1, wherein
the gap plate includes a positioning projection that projects from the edge of the gap plate at the position separated from the protrusions as seen along a normal direction of the gap plate, and
the positioning portion includes a recess that is provided in the inner surface of the bobbin and fits the positioning projection.

6. The reactor according to claim 1, wherein
the gap plate includes the protrusions at four corners on each of surfaces of the gap plate that face the end surfaces of the core blocks.

7. A method of manufacturing the reactor according to claim 1, the method comprising:
preparing the pair of core blocks and the gap plate that includes the plurality of protrusions on surfaces of the gap plate that are to face the end surfaces of the core blocks;
insert-molding bobbin parts for the core blocks respectively, each of the bobbin parts surrounding the side surface of corresponding one of the core blocks; and
arranging the core blocks to be opposed to each other such that the gap plate is interposed between the end surfaces of the core blocks with the protrusions being in contact with the end surfaces, and joining the bobbin parts to complete the bobbin;
wherein
the insert-molding of the bobbin parts includes forming the positioning portion that contacts the edge of the gap plate on at least one of the bobbin parts, the positioning portion being formed at a position separated from the protrusions of the gap plate in a state where the gap plate is attached to the at least one of the bobbin parts.
